(19) United States
(12) Patent Application Publication
(10) Pub. No.: US 2004/0175982 A1
(43) Pub. Date: Sep. 9, 2004

(54) Plug connector housing with locking mechanism and plug connector with locking mechanism using thereof

(75) Inventors: Keiji Kuroda, Amagasaki-shi (JP); Kiyoshi Aramoto, Osaka (JP); Ryo Moriwake, Osaka (JP)

Correspondence Address: FASSE PATENT ATTORNEYS, P.A., P.O. BOX 726, HAMPDEN, ME, 04444-0726, US

(73) Assignee: J. S. T. Mfg. Co., Ltd., Osaka (JP)

(21) Appl. No.: 10/792,965

(22) Filed: Mar. 4, 2004

(30) Foreign Application Priority Data
Mar. 7, 2003 (JP) 2003-62578

(51) Int. Cl. H01R 13/62

(52) U.S. Cl. 439/358

(57) ABSTRACT

Objective is providing a plug connector with locking mechanism, which can reconcile making the plug connector and the receptacle connector thinner and more compact, making the unlocking and withdrawal operations easier and reducing the forces required for unlocking with each other, and the like. A plug connector housing with locking mechanism comprising a housing having a body and an inserting part and receiving a contact, lock arms being provided on both sides in the width direction of the housing, extending rearward in the depth direction and having protrusions provided at the top ends thereof, and control arms being provided on both sides in the width direction of the housing, extending frontward in the depth direction and transmitting forces working inwardly in the width direction to the lock arms, and being arranged in such a way that when the inserting part is inserted into the cavity of the receptacle connector, the protrusions will be caught on the catching faces, and when the top ends of the control arms are pressed inwardly in the width direction, the protrusions will be released from the catching faces.

### BACKGROUND OF THE INVENTION

1. Field of the Invention

The present invention relates to a plug connector with locking mechanism, which will be locked in a receptacle connector when it is inserted into the receptacle connector and can be withdrawn out of the receptacle connector when unlocking operation is done on the plug connector, and to a plug connector housing with locking mechanism being a component thereof.

2. Related Art

Japanese Patent Publication 3094668 discloses a connector with locking mechanism comprising a plug connector, a molded cover enclosing the plug connector, lock levers being cantilevered respectively on the inward faces of both side walls in the width direction of a cover body constituting the molded cover, and a jack connector corresponding to the plug connector, wherein the connectors are locked together or unlocked by fitting or undoing of hooks provided on the other ends of the lock levers and fitting parts provided on the jack connector at positions corresponding to the hooks, and catching of the hooks on the fitting parts will be undone when tongues formed by key-shaped slits made in the side walls of the cover body are pressed from outside to undergo elastic deformation inwardly.

Japanese Utility Model Unexamined Publication Heisei 3-16674 discloses a locking mechanism of a connector comprising a cable-side body for receiving a socket made of an insulator for holding one set of contacts for electrical connection, a stand-side member for receiving a socket made of an insulator for holding the counterpart set of contacts, inner walls being provided on both sides inside the casing of the cable-side body and extending linearly in the longitudinal direction, outer walls limiting the outer side of the casing, lock plates provided in spaces between the inner walls and the outer walls, portions of the lock plates being close to one ends thereof and making point contact with protrusions provided on the inner walls, fitting protrusions being provided by making the other ends of the lock plates protrude outwardly from the outer walls of the casing so that the protrusions can fit into openings in the outer walls of the stand-side member, finger-shaped parts protruding inwardly from the intermediate parts of the lock plates to contact the outer walls of the inner walls to constantly position the fitting protrusions outside through spring action, and a cover member having finger-pressing parts for controlling the finger-shaped parts from the outside of the casing of the cable-side body.

Japanese Patent Unexamined Publication 2002-190351 discloses an electric connector comprising a first connector and a second connector for fitting together in a first direction and having a lock for locking the first connector and the second connector together, wherein the first connector is provided with a lock piece and unlocking arm for undoing the fitting of the lock piece, the lock piece being formed into an approximately L-shape and having a fitting part on one end thereof for fitting with a fitting part of the second connector and a protruding part on the other end thereof for contacting a cam of unlocking arm, the second connector is provided with a metallic shell having a catching part for fitting with the fitting part, when the first connector and the second connector are fitted together, the unlock arm will be displaced into a second direction crossing the first direction so as to make the cam and the protruding part contact with each other, to displace the lock piece into a third direction crossing the first and second directions and undo the fitting between the fitting part and the catching part.

In the case of the connector with locking mechanism of Japanese Patent Publication 3094668, the lock levers extend, inside the mold cover, on both sides of the plug connector from the rear to the front of the plug connector, and the hooks are released from the fitting parts of the counterpart jack connector by pressing the tongues with fingers to apply forces to the intermediate parts of the lock levers. In the case of the connector of Japanese Utility Model Unexamined Publication Heisei 3-16674, the lock plates extend, inside the casing of the cable-side body, on both sides of the socket from the rear to the front of the socket, and unlocking is effected by pressing the finger-pressing parts with fingers to apply forces to the intermediate parts of the lock plates so as to remove the protrusions for fitting from the openings of the counterpart stand-side member. As for connectors of this kind, it is keenly desired to minimize the forces required for unlocking. To solve this problem, the root end of the lock lever or the root end of the lock plate may be extended towards the rear of the plug connector or the socket. Or the point of action in which the force is applied to the lock lever or the lock plate may be shifted closer to the front of the plug connector of the socket. However, when the former measure is taken, the connectors will get larger in size, marring the efforts of making the connectors more compact. When the latter measure is taken, the tongue or the finger-pressing part is brought closer to the counterpart jack connector or socket, which makes it very difficult or impossible to unlock by pressing the tongues or the finger-pressing parts with fingers when the counterpart jack connector or socket is mounted in a narrow space leaving tight work space.

The connector of Japanese Patent Unexamined Publication 2002-190351 differs in the structure of locking mechanism from the connectors of Japanese Patent Publication 3094668 and Japanese Utility Model Unexamined Publication Heisei 3-16674, the lock pieces, however, extend on both sides of the plug connector from the rear to the front, and the fitting parts thereof are released from the fitting parts of the counterpart receptacle connector by pressing the unlocking arms with fingers to apply forces to the protruding parts of the lock pieces. Accordingly, when the root ends of the lock pieces are extended towards the rear of the plug connector, the connectors will get larger, marring the efforts of making them more compact. When the unlocking arms are extended towards the front of the plug connector for the same purpose, it will pose a problem that it is very difficult or impossible to unlock by pressing the unlocking arms with fingers when the counterpart receptacle connector is mounted in a narrow space with tight working space. Moreover, as the fitting part of the locking piece fits with the fitting part of the receptacle connector by being displaced in the thickness direction of the plug connector, this mars the efforts of reducing the plug connector and the receptacle connector in thickness.

### SUMMARY OF THE INVENTION

The present invention was made in view of the above-mentioned points, and its objective is to provide a plug connector housing with locking mechanism wherein the lock arms and the control arms are extended oppositely in the depth direction on both sides in the width direction of the housing to reconcile making the plug connector and the receptacle connector thinner and more compact, making the unlocking and withdrawal operations easier and reducing the forces required for unlocking with each other, and a plug connector with locking mechanism using thereof.

To accomplish the above-mentioned objective, the plug connector housing with locking mechanism according to the present invention is a plug connector housing with locking mechanism constituting, together with a plug-connector side contact, a plug connector with locking mechanism to be inserted into or withdrawn from a receptacle connector having, when a depth direction, a width direction and a thickness direction being perpendicular to each other are assumed, a cavity opening frontward in the depth direction, catching faces being provided at both ends in the width direction of the cavity and facing rearward in the depth direction, and a receptacle-connector side contact provided in the cavity, the plug connector housing with locking mechanism comprising a housing having a body, an inserting part being provided on the rear side in the depth direction of the body and being to be inserted into the cavity of the receptacle connector, a receiving part to receive the plug-connector side contact so that a contacting part thereof is exposed on the surface of the inserting part, the housing being at least partly insulative, flexible lock arms being arranged on both sides in the width direction of the housing, of which root ends being provided on the body of the housing, the lock arms extending rearward in the depth direction and up to the outer sides in the width direction of the inserting part and having protrusions, at the top ends thereof, extending outward in the width direction, and flexible control arms being arranged on both sides in the width direction of the housing, of which root ends being provided on the body of the housing on the rear side in the depth direction of the root ends of the lock arms, the control arms extending frontward in the depth direction, and the intermediate parts thereof being arranged to transmit forces working inwardly in the width direction to the intermediate parts of the lock arms, and being arranged in such a way that when the inserting part of the housing is inserted into the cavity of the receptacle connector, the protrusions of the lock arms will be caught on the catching faces of the receptacle connector, and when the top ends of the control arms are pressed inwardly in the width direction, the protrusions of the lock arms will be displaced inwardly in the width direction to be released from the catching faces of the receptacle connector.

When the plug-connector-side contact is set in the receiving part of this plug connector housing with locking mechanism to form the plug connector with locking mechanism and this plug connector is inserted into the receptacle connector so that the inserting part is inserted into the cavity, the lock arms will be flexed, the protrusions of the lock arms will be displaced inwardly in the width direction and will return, and in turn, the protrusions will be hooked on the catching faces of the receptacle connector. This, in turn, will lock the plug connector with locking mechanism to the receptacle connector. When the top ends of the control arms are pressed inwardly in the width direction by fingers, the forces will be transmitted from the intermediate parts of the control arms to the intermediate parts of the lock arms, the lock arms will be flexed, the protrusions will be displaced inwardly in the width direction to be released from the catching faces of the receptacle connector. As a result, the plug connector with locking mechanism will be unlocked from the receptacle connector, enabling the plug connector with locking mechanism to be withdrawn from the receptacle connector.

In that case, as the lock arms and the control arms are located on both sides in the width direction of the housing and these arms are flexed in the width direction, the plug connector with locking mechanism and the receptacle connector can be reduced in thickness. As the intermediate part of the control arm transmits the force to the intermediate part of the lock arm, the latter intermediate part serves as the point of action for the force working from the control arm to the lock arm, and the control arm extends further more from the intermediate part frontward in the depth direction, it is sufficient to apply a smaller force to the top end of the control arm by a finger because of the principle of leverage. Thus the force required for unlocking can be reduced. As the control arm extends frontward in the depth direction, the top end of the control arm can be spaced as much as possible, frontward in the depth direction, from the receptacle connector. Accordingly, even when the receptacle connector is mounted in a narrow space leaving tight work space, it is easy to undo the locking by pressing the control arms by fingers. As the lengths of the lock arm and the control arm are not extended to excessively exceed the length of the housing in the depth direction, the plug connector with locking mechanism and the receptacle connector can be made more compact.

In the plug connector housing with locking mechanism according to the present invention the lock arms and the control arms are extended oppositely in the depth direction on both sides in the width direction of the housing. As a result, the present invention has successfully provided a plug connector housing with locking mechanism wherein making the plug connector with locking mechanism and the receptacle connector thinner and more compact, making the unlocking and withdrawal operations easier and reducing the forces required for unlocking are made compatible with each other.

The plug connector with locking mechanism according to the present invention comprises the plug connector housing with locking mechanism and the plug-connector-side contact inserted in the receiving part of the plug connector housing with locking mechanism.

In the plug connector with locking mechanism according to the present invention the lock arms and the control arms are extended oppositely in the depth direction on both sides in the width direction of the housing. As a result, the present invention has successfully provided a plug connector with locking mechanism wherein making the plug connector with locking mechanism and the receptacle connector thinner and more compact, making the unlocking and withdrawal operations easier and reducing the forces required for unlocking are made compatible with each other.

### BRIEF DESCRIPTION OF THE DRAWINGS

FIG. 1 is a perspective view of the plug connector housing with locking mechanism of an embodiment of the present invention.

FIG. 2 is an enlarged plan view of the plug connector housing with locking mechanism of the embodiment seen in the thickness direction thereof.

FIG. 3 is an enlarged bottom view of plug connector housing with locking mechanism of the embodiment seen oppositely in the thickness direction thereof.

FIG. 4 is an enlarged side view of the plug connector housing with locking mechanism of the embodiment seen in the width direction thereof.

FIG. 5 is an enlarged sectional view of the plug connector housing with locking mechanism of the embodiment seen in section in the width direction thereof.

FIG. 6 is a perspective view showing the state of inserting wired contacts into the plug connector housing with locking mechanism of the embodiment.

FIG. 7 is a perspective view showing the state of the plug connector housing with locking mechanism of the embodiment in which the wired contacts have been inserted or the wired plug connector with locking mechanism.

FIG. 8 is an enlarged perspective view of a part of the plug connector housing with locking mechanism of the embodiment with wired contacts having been inserted therein or the wired plug connector with locking mechanism.

FIG. 9 is an enlarged perspective view showing the plug connector housing with locking mechanism of the embodiment from which a part extending from the shell to one side end wall is cut away.

FIG. 10 is a perspective view of the receptacle connector of the embodiment.

FIG. 11 is an enlarged front view of the receptacle connector of the embodiment seen from the front side in the depth direction.

FIG. 12 is an enlarged sectional view of the receptacle connector of the embodiment seen in section in the thickness direction.

FIG. 13 is an enlarged sectional view of the receptacle connector of the embodiment seen in section in the width direction.

FIG. 14 is a perspective view showing the state of inserting the plug connector with locking mechanism of the embodiment into the receptacle connector.

FIG. 15 is a perspective view showing the plug connector with locking mechanism of the embodiment having been inserted in the receptacle connector.

FIG. 16 is an enlarged sectional view of the receptacle connector seen in section in the thickness direction, with the plug connector with locking mechanism of the embodiment having been inserted in the receptacle connector.

FIG. 17 is an enlarged sectional view of the plug connector with locking mechanism of the embodiment having been inserted in the receptacle connector seen in section in the width direction.

### PREFERRED EMBODIMENT OF THE INVENTION

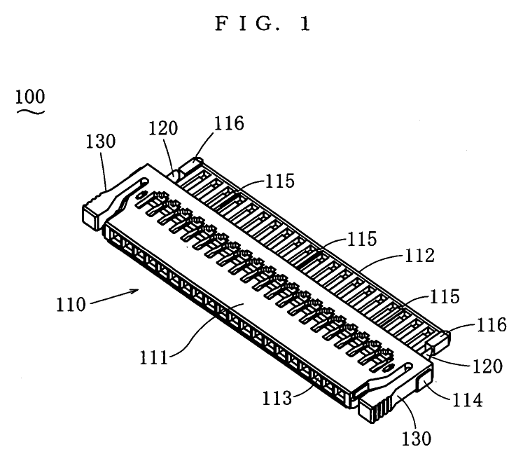

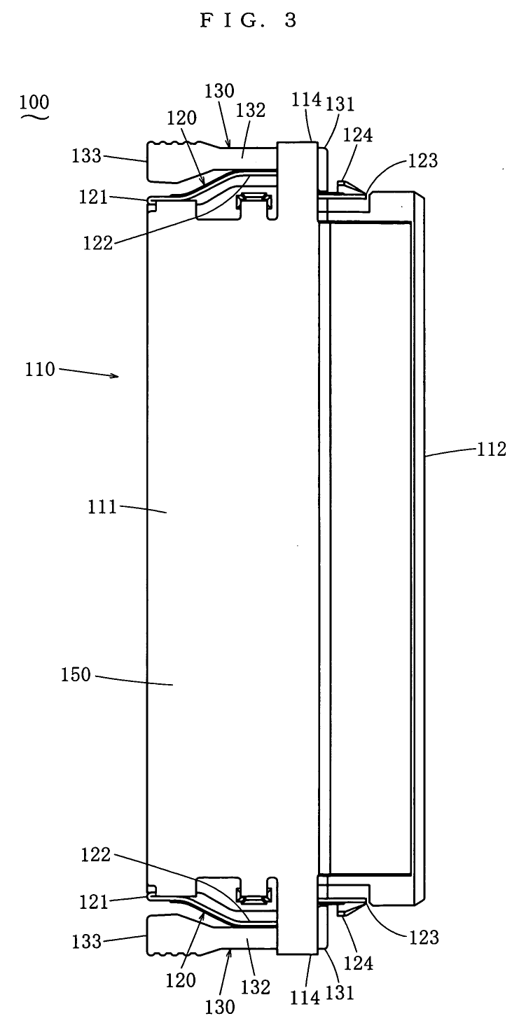

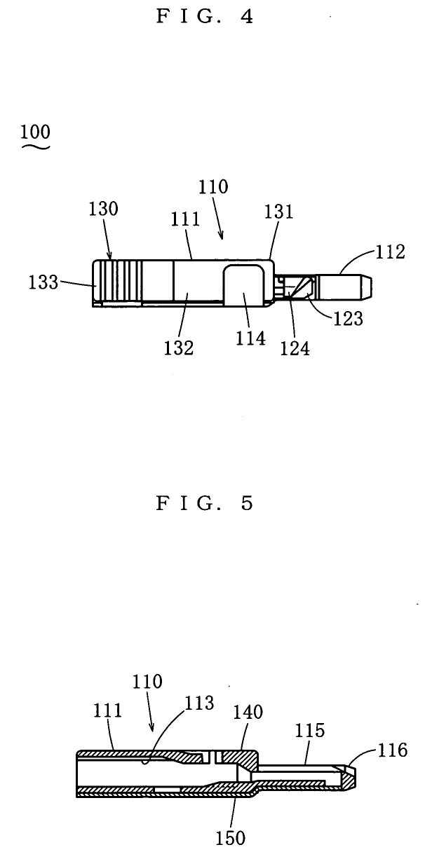

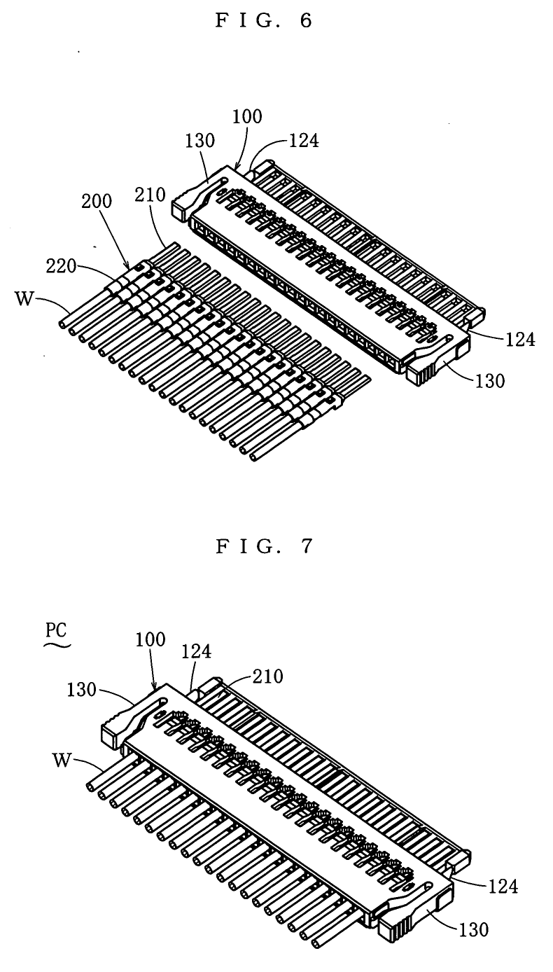

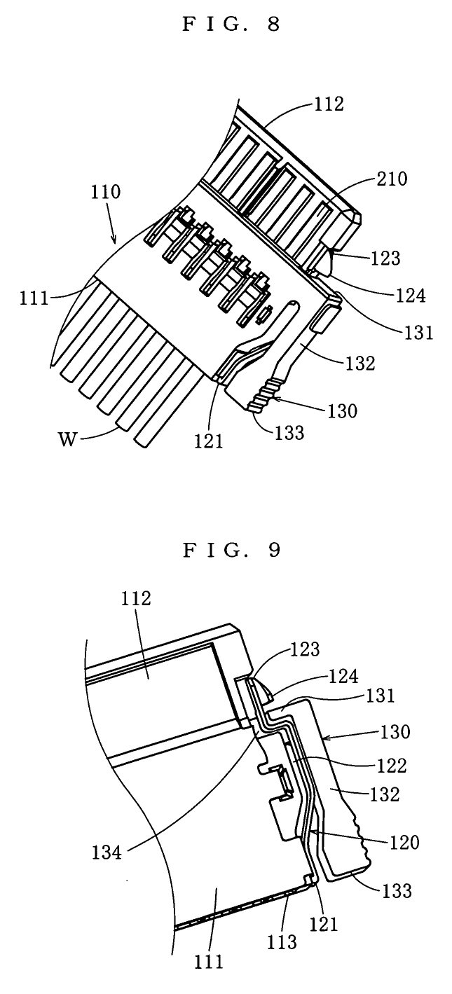

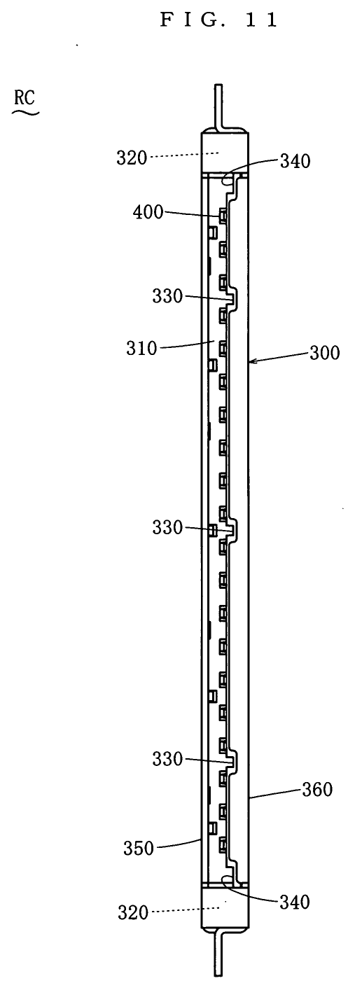

In the following an embodiment of the present invention will be described. FIG. 1 through FIG. 5 show a plug connector housing with locking mechanism 100 being an embodiment of the present invention. FIG. 7 and FIG. 8 show a plug connector with locking mechanism PC comprising the plug connector housing with locking mechanism 100 and plug-connector-side contacts 200 (refer to FIG. 6) to be inserted thereto. This plug connector with locking mechanism PC is to be inserted into or withdrawn from a receptacle connector RC shown in FIG. 10 through FIG. 13. In the case of this embodiment, the plug connector with locking mechanism PC is connected to electric wires W being independent discrete lines, and the receptacle connector RC is mounted on a printed circuit board B being a liquid crystal panel. The plug connector with locking mechanism according to the present invention, however, is not limited in any way by this embodiment in what to be connected to it. Moreover, the receptacle connector is not limited by this embodiment in any way in what to be connected to it. The plug connector with locking mechanism according to the present invention can be connected to, in addition to discrete lines, electric wires such as coaxial lines or twisted lines or flat-type flexible cables such as flexible flat cables (FFC) or flexible printed circuits (FPC). The receptacle connector can be connected to, in addition to printed circuit boards, for example, members having conductors.

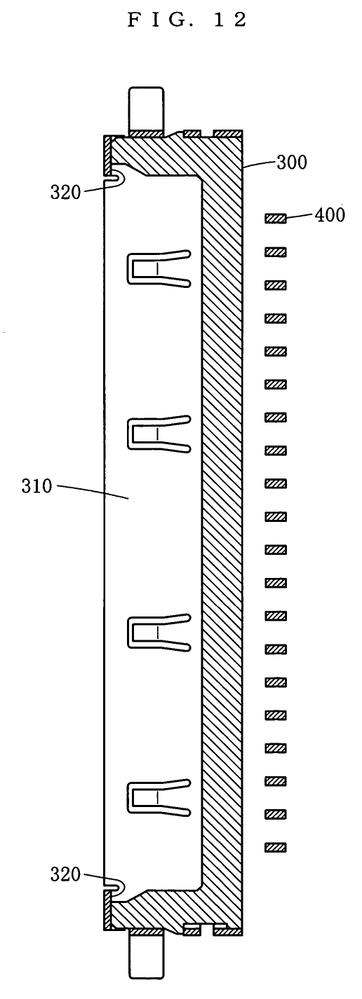

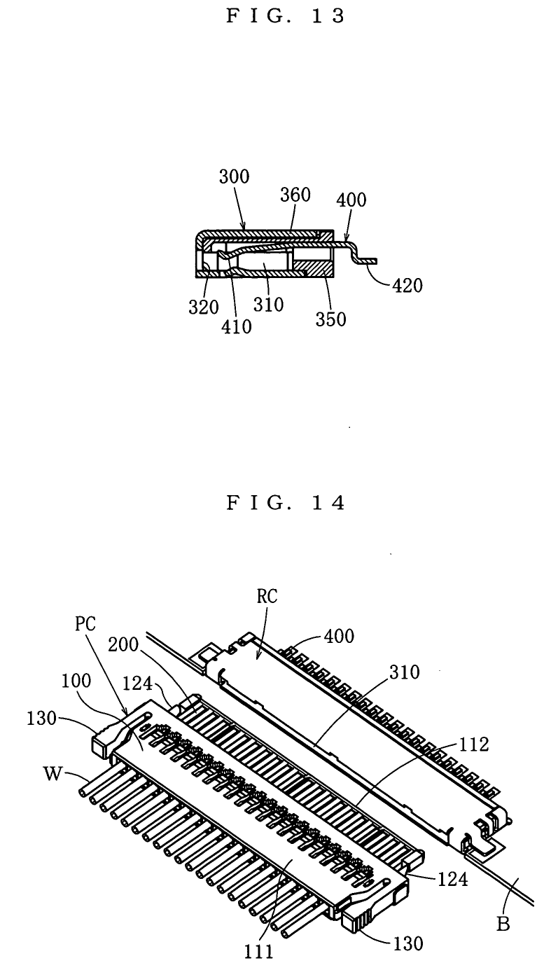

As shown in FIG. 10 through FIG. 13, the receptacle connector RC comprises the receptacle connector housing 300 and the receptacle-connector-side contacts 400. A depth direction, a width direction and a thickness direction all being perpendicular to each other are assumed and this orientation is used for description. In the case of this embodiment, with reference to FIG. 12, the left-right direction of the diagram is the depth direction, and the left of the diagram is the front side in the depth direction, and the right of the diagram is the rear side in the depth direction. The top-bottom direction of FIG. 12 is the width direction, and the direction perpendicular to the plane of the paper is the thickness direction. The receptacle connector housing 300 is provided with a cavity 310 being open frontward in the depth direction and catching faces 320 being provided on both ends in the width direction of the cavity 310 and facing rearward in the depth direction. In this embodiment small pieces facing rearward are made to protrude from both ends in the width direction of the cavity 310 inwardly in the width direction, and the rearward faces of these small pieces in the depth direction are made to serve as the catching faces 320. The inner side in the width direction is defined, when an approximately central part of the receptacle connector housing 300 is used as a reference point, as a side closer to the central part in the width direction. As for other ways of providing the catching faces, the inner faces in the width direction of both end walls in the width direction of the cavity may be concaved, and the faces facing rearward in the depth direction of the concaved parts may be used as the catching faces. Each receptacle-connector-side contact 400 is formed of a conductive member, comprises a contacting part 410, which contacts the plug-connector-side contact 200 that will be explained later, and a connecting part 420 to be connected to a printed circuit board B, and is fitted in the receptacle connector housing 300 so that the contacting part 410 is located in the cavity 310.

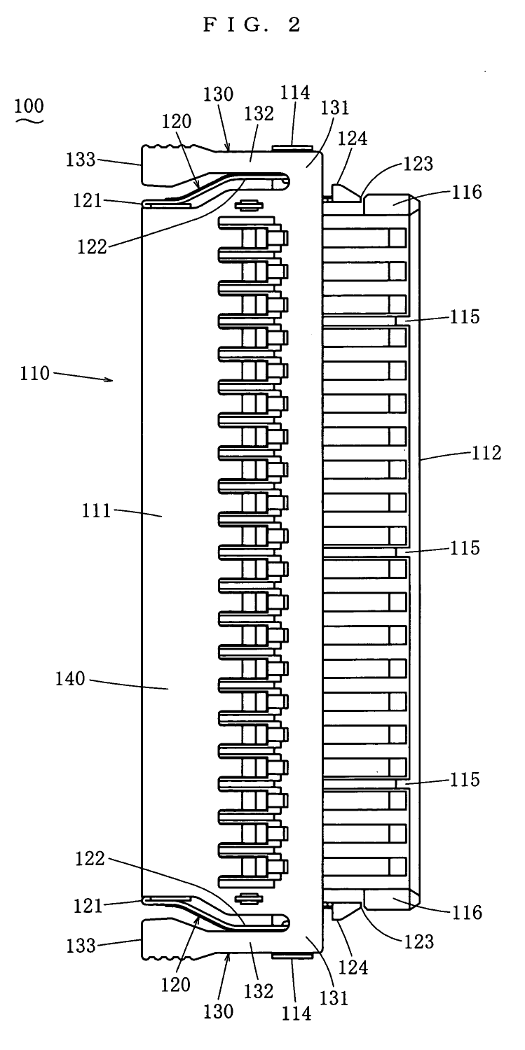

The orientation of the plug connector housing with locking mechanism 100 is similar to the orientation described above. With reference to FIG. 2, the left-right direction of the diagram is the depth direction, and the left of the diagram is the front side in the depth direction, and the right is the rear side in the depth direction. The top-bottom direction of FIG. 2 is the width direction, and the direction perpendicular to the plane of the paper is the thickness direction. As shown in FIG. 1 through FIG. 5, the plug connector housing with locking mechanism 100 comprises a housing 110, which is at least partly insulative, flexible lock arms 120 and flexible control arms 130.

The housing 110 comprises a body 111 and an inserting part 112, which is provided on the rear side in the depth direction of the body 111 and is to be inserted into the cavity 310 of the receptacle connector RC. The housing 110 is provided with receiving parts 113 for receiving the plug-connector-side contacts 200. The plug-connector-side contact 200 is formed of a conductive member and is provided with a contacting part 210, which is to contact the contacting part 410 of the receptacle-connector-side contact 400, and a connecting part 220 to be connected to an electric wire W. The plug-connector-side contact 200 is received in the receiving part 113 so that its contacting part 210 is exposed on the surface of the inserting part 112. The plug-connector-side contacts 200 are fitted in the housing 110 by using housing lance structure or contact lance structure, if necessary. In the case of this embodiment, the plug-connector-side contacts are of the crimp termination type, but they may be of the insulation displacement termination type or of a structure wherein an electric wire is connected by piercing or another method.

As shown in FIG. 1 through FIG. 4 and FIG. 6 through FIG. 9, lock arms 120 are formed into rods and are arranged on both sides in the width direction of the housing 110. The root end 121 of each lock arm 120 is fixed onto the body 111 of the housing 110 and the lock arm 120 is cantilevered. In the case of this embodiment, the root end 121 of the lock arm 120 is provided approximately at the frontward end in the depth direction of the body 111, but the position of the root end 121 is not limited in any way to it. Each lock arm 120 extends rearward in the depth direction up to the outer sides in the width direction of the inserting part 112. A protrusion 124 protruding outwardly in the width direction is provided on the top end 123 of each lock arm 120. The outer side in the width direction means, when an approximately central part of the housing 110 is used as the reference, the remoter side from the central part in the width direction. The inner side in the width direction means the closer side to the central part in the width direction.

As shown in FIG. 1 through FIG. 4 and in FIG. 6 through FIG. 9, the control arms 130 are formed into rods and are arranged on both sides in the width direction of the housing 110. Each control arm 130 is cantilevered with its root end 131 being fixed on the body 111 of the housing 110 at a point deeper in the depth direction than the root end 121 of the lock arm 120. In the case of the present embodiment, the root end 131 of the control arm 130 is provided approximately at the rearward end in the depth direction of the body 111. The position of the root end 131, however, is not limited to this in any way. Each control arm 130 extends frontward in the depth direction. In the case of this embodiment, the top end 133 of the control arm 130 extends approximately up to the frontward end in the depth direction of the body 111. The position of the top end 133, however, is not limited to this point in any way. Each control arm 130 is arranged so that its intermediate part 132 transmits a force working inwardly in the width direction to the intermediate part 122 of the lock arm 120.

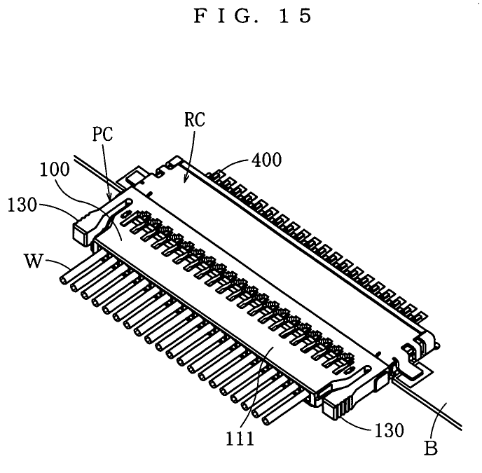

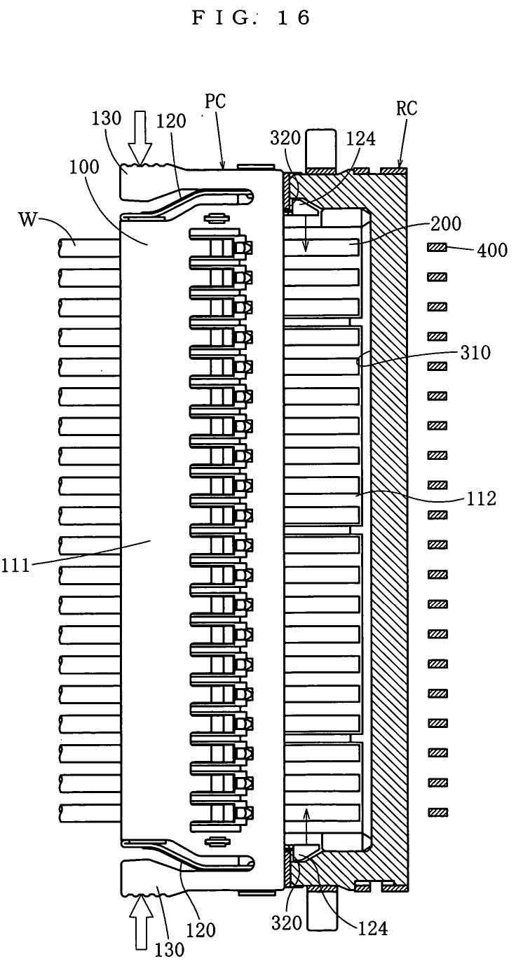

With the arrangement described above, when the inserting part 112 of the housing 110 is inserted into the cavity 310 of the receptacle connector RC, the protrusions 124 of the lock arms 120 will be caught on the catching faces 320 of the receptacle connector RC. And when the top ends 133 of the control arms 130 are pushed inward in the width direction, the protrusions 124 of the lock arms 120 will be displaced inward in the width direction and released from the catching faces 320 of the receptacle connector RC (refer to FIG. 14 through FIG. 17).

The housing 110 is provided as an approximately rectangular form having two sides extending in the depth direction and the width direction when seen in the thickness direction. It is preferable to form the rearward end in the depth direction of the housing 110 into a wedge shape getting thinner towards the top end when seen in the width direction. With this arrangement, it is easier to insert the plug connector with locking mechanism PC into the receptacle connector RC. The shape of the housing 110, however, is not limited in any way by this embodiment.

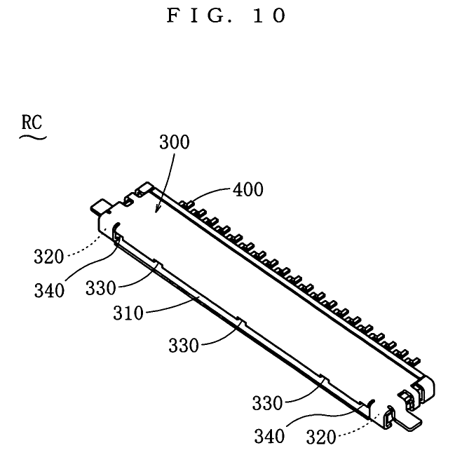

As shown in FIG. 9, the lock arm 120 and the control arm 130 cross each other when seen in the thickness direction. At least, either the lock arm 120 or the control arm 130 is provided with an avoiding part that is concaved in the thickness direction to avoid interference with the counterpart arm. In the case of this embodiment, the control arm 130 is provided with an avoiding part 134 in the form of a groove concaving on one side thereof in the thickness direction. A portion in the longitudinal direction of the lock arm 120 is received in this avoiding part 134. The dimension in the width direction of the avoiding part 134 is set greater than the width of the portion of the lock arm 120 being received therein, enabling the lock arm 120 to be displaced in the width direction. The avoiding part may be provided in the lock arm or in both the lock arm and the control arm.

As shown in FIG. 9, the intermediate part 132 of the control arm 130 is located on the outer side in the width direction of the intermediate part 122 of the lock arm 120, and the intermediate part 132 of the control arm 130 is arranged to press the intermediate part 122 of the lock arm 120 on the outer side thereof in the width direction to transmit a force working inward in the width direction.

As shown in FIG. 1 through FIG. 9, the plug connector housing with locking mechanism 100 comprises the insulating member 140 being insulative and the shell 150 being conductive and being put over the insulating member 140. The housing 110 and the control arms 130 are formed by the insulating member 140. The lock arms 120 are formed by some portions of the shell 150. In the case of this embodiment, the receptacle connector housing 300 also comprises an insulating member 350 being insulative and a shell 360 being conductive and being put over the insulating member 350. Both housings are arranged in such a way that when the plug connector with locking mechanism PC is inserted into the receptacle connector RC, both shells thereof will contact with each other. In that case, if the shell 360 of the receptacle connector housing 300 is connected to the grounding pattern of the printed circuit board B, the shielding effects of both connectors PC and RC will be enhanced. The present invention includes embodiments wherein the receptacle connector housing 300 does not comprise such two members.

If the plug connector housing with locking mechanism 100 comprises the insulating member 140 and the shell 150 having a greater strength than that of the insulating member 140, the strength of the control arms 130 can be increased or the control arms 130 can be prevented from excessive deformation by providing the shell 150 with side end walls 114 rising along the outer faces in the width direction of the control arms 130. The present invention includes embodiments wherein no side end wall 114 is provided.

Contacts 200, 400 are arranged in one row in the width direction and in one stage in the thickness direction in both the plug connector with locking mechanism PC and the receptacle connector RC. Hence, as shown in FIG. 1 through FIG. 9, the receiving parts 113 are arranged in one stage in the thickness direction and in a plurality of rows in the width direction in the housing 110.

The plug connector housing with locking mechanism 100 is provided with first restricting parts 115 for preventing prying, and in correspondence to them, the receptacle connector housing 300 is provided with first restricting parts 330. In other words, ribs 115 being the first restricting parts extending in the depth direction are provided on the inserting part 112 of the plug connector housing with locking mechanism 100 at appropriate locations in the width direction thereof, and grooves 330 being the counterpart first restricting parts for receiving the above-mentioned ribs 115 are provided in the receptacle connector housing 300. With this provision of the first restricting parts 115, 330, for example, when the plug connector with locking mechanism PC is inserted into the receptacle connector RC at an angle seen in the thickness direction rather than straight in the depth direction, the first restricting parts 115, 330 will not fit together properly, preventing the insertion. In this way, prying can be prevented. The inserting part 112 of the plug connector housing with locking mechanism 100 may be provided with grooves as the first restricting parts, and the receptacle connector housing 300 with ribs as the first restricting parts. The present invention includes embodiments wherein the first restricting parts 115, 330 are not provided.

The plug connector housing with locking mechanism 100 is provided with second restricting parts 116 for preventing reverse insertion, and in correspondence with this, the receptacle connector housing 300 is provided with second restricting parts 340. In other words, the inserting part 112 of the plug connector housing with locking mechanism 100 is provided with ribs 116 rising on one side in the thickness direction as the second restricting parts, and in correspondence to it, the receptacle connector housing 300 is provided with grooves 340 for receiving the above-mentioned ribs 116 as the counterpart second restricting parts. In the case of this embodiment, the second restricting parts 116, 340 are provided on both ends in the width direction of the plug connector housing with locking mechanism 100 and the receptacle connector housing 300. The locations of the second restricting parts, however, are not limited in any way by this embodiment. With the provision of the second restricting parts 116, 340, when, for example, one reverses the plug connector with locking mechanism PC in the thickness direction from its regular position and attempts to insert it into the receptacle connector RC, the plug connector PC can not be inserted because the second restricting parts 116, 340 can not fit together. This prevents reverse insertion. A variety of pairs of a plug connector with locking mechanism PC and a receptacle connector RC may be set to have different numbers of poles. When a plug connector with locking mechanism PC and a receptacle connector RC, of which numbers of poles differ from each other, are attempted to be connected together, their second restricting parts 116, 340 can not be fitted together and in turn these connectors can not be connected up. The inserting part 112 of the plug connector housing with locking mechanism 100 may be provided with grooves as the second restricting parts, and the receptacle connector housing 300 may be provided with ribs as the second restricting parts. The present invention includes embodiments wherein the second restricting parts 116, 340 are not provided.

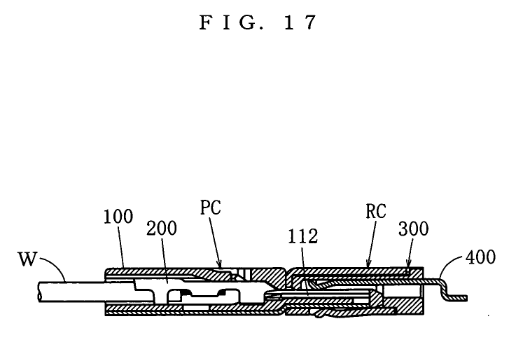

When the plug-connector-side contacts 200 are set in the receiving parts 113 of this plug connector housing with locking mechanism 100 to form the plug connector with locking mechanism PC and this plug connector is inserted into the receptacle connector RC so that the inserting part 112 is inserted into the cavity 310, the lock arms 120 will be flexed, the protrusions 124 of the lock arms 120 will be displaced inwardly in the width direction and will return. As a result, the protrusions 124 will be caught on the catching faces 320 of the receptacle connector RC. This, in turn, will lock the plug connector with locking mechanism PC to the receptacle connector RC. When the top ends 133 of the control arms 130 are pressed inwardly in the width direction (the directions indicated by the thicker allows in FIG. 16) by fingers, the forces will be transmitted from the intermediate parts 132 of the control arms 130 to the intermediate parts 122 of the lock arms 120, the lock arms 120 will be flexed, and the protrusions 124 will be displaced inwardly in the width direction (the directions indicated by the narrow arrows in FIG. 16) to be released from the catching faces of the receptacle connector RC. This, in turn, unlock the plug connector with locking mechanism PC from the receptacle connector RC, enabling the plug connector with locking mechanism PC to be withdrawn from the receptacle connector RC. It should be noted that the control arms 130 and the lock arms 120 contact with each other by their intermediate parts 122, 132. Strictly speaking, however, the locations of such contacts shift a little in response to the displacements of the intermediate parts 122, 132.

In that case, as the lock arms 120 and the control arms 130 are located on both sides in the width direction of the housing 110 and these arms are flexed in the width direction, the plug connector with locking mechanism PC and the receptacle connector RC can be reduced in thickness. As the intermediate part 132 of the control arm 130 transmits the force to the intermediate part 122 of the lock arm 120, the intermediate part 132 serves as the point of action for the force working from the control arm 130 to the lock arm 120 and the control arm 130 extends more from the intermediate part 132 frontward in the depth direction, it is sufficient to apply a smaller force to the top end of the control arm 130 by a finger because of the principle of leverage. Thus the force required for unlocking can be reduced. As the control arm 130 extends frontward in the depth direction, the top end 133 of the control arm 130 can be spaced as much as possible, frontward in the depth direction, from the receptacle connector RC. Accordingly, even when the receptacle connector RC is mounted in a narrow space leaving tight work space, it is easy to undo the locking by pressing the control arms 130 by fingers. As the lengths of the lock arm 120 and the control arm 130 are not extended to excessively exceed the length of the housing 110 in the depth direction, the plug connector with locking mechanism PC and the receptacle connector RC can be made more compact.

The present invention includes embodiments wherein the lock arm and the control arm are arranged parallel to each other when seen in the thickness direction and embodiments wherein the lock arm and the control arm overlap with each other when seen in the thickness direction. Of these embodiments, in the case of the above-mentioned embodiment, the lock arm 120 and the control arm 130 cross with each other when seen in the thickness direction, and at least either the lock arm 120 or the control arm 130 is provided with an avoiding part 134 being concaved in the thickness direction to avoid interference with the other arm. With this arrangement, the plug connector with locking mechanism PC and the receptacle connector RC can be reduced further in thickness.

The present invention includes all embodiments wherein the intermediate part of the control arm is arranged to transmit a force working inwardly in the width direction to the intermediate part of the lock arm. Accordingly, the present invention does not limit the relative positional relationship between the lock arm and the control arm. The present invention also include's embodiments wherein the intermediate part of the control arm is arranged to catch the intermediate part of the lock arm and push or pull it inwardly in the width direction when the former is displaced inwardly in the width direction. Among these embodiments, in the case of the above-mentioned embodiment, the intermediate part 132 of the control arm 130 is located on the outer side in the width direction of the intermediate part 122 of the lock arm 120, and the intermediate part 132 of the control arm 130 is arranged to contact the intermediate part 122 of the lock arm 120 from the outer side in the width direction to transmit the force working inwardly in the width direction. With this arrangement, as the force is transmitted from the intermediate part 132 of the control arm 130 to the intermediate part 122 of the lock arm 120 by a simple structure, it is easy to produce the plug connector housing with locking mechanism 100.

The present invention includes embodiments wherein the housing is entirely made of an insulative material. Among them, in the case of the above-mentioned embodiment, the plug connector housing with locking mechanism 100 comprises the insulating member 140 being insulative and the shell 150 being put over the insulating member 140 and being conductive, the housing 110 and control arms 130 are formed of the insulating member 140, and the lock arms 120 are formed of some portions of the shell 150. With this arrangement, the shielding performance of the plug connector with locking mechanism PC is enhanced by the shell 150. When the shell 150 is formed of a material of which strength is higher than that of the insulating member 140, the strength of the lock arms will be enhanced. As an example, embodiments wherein the shell 150 is formed of a metal may be proposed.

The present invention does not limit the number of contacts and their arrangement. Among them, in the case of the above-mentioned embodiment, the contacts 200, 400 are arranged in one row in the width direction and in one stage in the thickness direction in the plug connector with locking mechanism PC and the receptacle connector RC. Accordingly, the receiving parts 113 are arranged in one stage in the thickness direction and in a plurality of rows in the width direction in the housing 110. With this arrangement, the plug connector with locking mechanism PC and the receptacle connector RC can be reduced in thickness effectively.

In the above-mentioned embodiment electric wires W are connected to the plug connector with locking mechanism PC. If a flat-type flexible cable is to be connected, the connecting parts of the plug-connector-side contacts are arranged to connect the flat-type flexible cable. In this case, for example, the connecting parts may be provided with protrusions for piercing.

With the description of these embodiments the first plug connector housing with locking mechanism and the first plug connector with locking mechanism that were explained in Summary of the Invention above have been described fully. Moreover, with the description of these embodiments the second through fifth plug connector housings with locking mechanism and the second plug connector with locking mechanism comprising the plug connector housing with locking mechanism, which are to be explained below, have been described fully.

The second plug connector housing with locking mechanism is the first plug connector housing with locking mechanism wherein the lock arms and the control arms cross with each other seen in the thickness direction, and at least either the lock arm or the control arm is provided with an avoiding part being concaved in the thickness direction to avoid interference with the other.

With this arrangement, the plug connector with locking mechanism and the receptacle connector can be reduced further in the thickness.

The third plug connector housing with locking mechanism is the first or the second plug connector housing with locking mechanism wherein the intermediate part of the control arm is located on the outer side in the width direction of the intermediate part of the lock arm, and the intermediate part of the control arm is arranged to transmit a force working inwardly in the width direction to the intermediate part of the lock arm by contacting the intermediate part of the lock arm from the outer side in the width direction.

With this arrangement, as the force is transmitted from the intermediate part of the control arm to the intermediate part of the lock arm by a simple structure, it is easy to produce the plug connector housing with locking mechanism.

The fourth plug connector housing with locking mechanism is any one of the first through third plug connector housings with locking mechanism wherein the plug connector housing comprises an insulating member being insulative and a shell being conductive and being put over the insulating member, and the housing and the control arms are formed of the insulating member, and the lock arms are formed of some portions of the shell.

With this arrangement, the shielding performance of the plug connector with locking mechanism is enhanced by the shell. If the shell is formed of a material of which strength is greater than that of the insulating member, the strength of the lock arms will be enhanced.

The fifth plug connector housing with locking mechanism is any one of the first through fourth plug connector housings with locking mechanism wherein the receiving parts are arranged in one stage in the thickness direction and in a plurality of rows in the width direction in the housing.

With this arrangement, the plug connector with locking mechanism and the receptacle connector can be reduced in thickness effectively.

The second plug connector with locking mechanism according to the present invention comprises any one of the second through fifth plug connector housings with locking mechanism and the plug-connector-side contact inserted in the receiving part of the plug connector housing with locking mechanism.

In the plug connector with locking mechanism according to the present invention the lock arms and the control arms are extended oppositely in the depth direction on both sides in the width direction of the housing. As a result, the present invention has successfully provided a plug connector with locking mechanism wherein making the plug connector with locking mechanism and the receptacle connector thinner and more compact, making the unlocking and withdrawal operations easier and reducing the forces required for unlocking are made compatible with each other.

What is claimed is:

1. A plug connector housing with locking mechanism constituting, together with a plug-connector side contact, a plug connector with locking mechanism to be inserted into or withdrawn from a receptacle connector having, when a depth direction, a width direction and a thickness direction being perpendicular to each other are assumed, a cavity opening frontward in the depth direction, catching faces being provided at both ends in the width direction of the cavity and facing rearward in the depth direction, and a receptacle-connector side contact provided in the cavity, the plug connector housing with locking mechanism comprising
a housing having a body, an inserting part being provided on the rear side in the depth direction of the body and being to be inserted into the cavity of the receptacle connector, a receiving part to receive the plug-connector side contact so that a contacting part thereof is exposed on the surface of the inserting part, the housing being at least partly insulative,
flexible lock arms being arranged on both sides in the width direction of the housing, of which root ends being provided on the body of the housing, the lock arms extending rearward in the depth direction and up to the outer sides in the width direction of the inserting part and having protrusions, at the top ends thereof, extending outward in the width direction, and
flexible control arms being arranged on both sides in the width direction of the housing, of which root ends being provided on the body of the housing on the rear side in the depth direction of the root ends of the lock arms, the control arms extending frontward in the depth direction, and the intermediate parts thereof being arranged to transmit forces working inwardly in the width direction to the intermediate parts of the lock arms, and
being arranged in such a way that when the inserting part of the housing is inserted into the cavity of the receptacle connector, the protrusions of the lock arms will be caught on the catching faces of the receptacle connector, and when the top ends of the control arms are pressed inwardly in the width direction, the protrusions of the lock arms will be displaced inwardly in the width direction to be released from the catching faces of the receptacle connector.

2. The plug connector housing with locking mechanism of claim 1, wherein the lock arms and control arms cross with each other seen in the thickness direction, and at least either the lock arm or the control arm is provided with an avoiding part being concaved in the thickness direction to avoid interference with the other.

3. The plug connector housing with locking mechanism of claim 1, wherein the intermediate part of the control arm is located on the outer side in the width direction of the intermediate part of the lock arm, and the intermediate part of the control arm is arranged to transmit a force working inwardly in the width direction to the intermediate part of the lock arm by contacting the intermediate part of the lock arm from the outer side in the width direction.

4. The plug connector housing with locking mechanism of claim 2, wherein the intermediate part of the control arm is located on the outer side in the width direction of the intermediate part of the lock arm, and the intermediate part of the control arm is arranged to transmit a force working inwardly in the width direction to the intermediate part of the lock arm by contacting the intermediate part of the lock arm from the outer side in the width direction.

5. The plug connector housing with locking mechanism of claim 1, wherein the plug connector housing comprises an insulating member being insulative and a shell being conductive and being put over the insulating member,
the housing and the control arms are formed of the insulating member, and
the lock arms are formed of some portions of the shell.

6. The plug connector housing with locking mechanism of claim 2, wherein the plug connector housing comprises an insulating member being insulative and a shell being conductive and being put over the insulating member,
the housing and the control arms are formed of the insulating member, and
the lock arms are formed of some portions of the shell.

7. The plug connector housing with locking mechanism of claim 3, wherein the plug connector housing comprises an insulating member being insulative and a shell being conductive and being put over the insulating member,
the housing and the control arms are formed of the insulating member, and
the lock arms are formed of some portions of the shell.

8. The plug connector housing with locking mechanism of claim 4, wherein the plug connector housing comprises an insulating member being insulative and a shell being conductive and being put over the insulating member,
the housing and the control arms are formed of the insulating member, and
the lock arms are formed of some portions of the shell.

9. The plug connector housing with locking mechanism of claim 1, wherein the receiving parts are arranged in one stage in the thickness direction and in a plurality of rows in the width direction in the housing.

10. The plug connector housing with locking mechanism of claim 2, wherein the receiving parts are arranged in one stage in the thickness direction and in a plurality of rows in the width direction in the housing.

11. The plug connector housing with locking mechanism of claim 3, wherein the receiving parts are arranged in one stage in the thickness direction and in a plurality of rows in the width direction in the housing.

12. The plug connector housing with locking mechanism of claim 4, wherein the receiving parts are arranged in one stage in the thickness direction and in a plurality of rows in the width direction in the housing.

13. The plug connector housing with locking mechanism of claim 5, wherein the receiving parts are arranged in one stage in the thickness direction and in a plurality of rows in the width direction in the housing.

14. The plug connector housing with locking mechanism of claim 6, wherein the receiving parts are arranged in one stage in the thickness direction and in a plurality of rows in the width direction in the housing.

15. The plug connector housing with locking mechanism of claim 7, wherein the receiving parts are arranged in one stage in the thickness direction and in a plurality of rows in the width direction in the housing.

16. The plug connector housing with locking mechanism of claim 8, wherein the receiving parts are arranged in one stage in the thickness direction and in a plurality of rows in the width direction in the housing.

17. A plug connector with locking mechanism comprising the plug connector housing with locking mechanism of claim 1 and the plug-connector-side contact inserted in the receiving part of the plug connector housing with locking mechanism.

18. A plug connector with locking mechanism comprising the plug connector housing with locking mechanism of claim 2 and the plug-connector-side contact inserted in the receiving part of the plug connector housing with locking mechanism.

19. A plug connector with locking mechanism comprising the plug connector housing with locking mechanism of claim 3 and the plug-connector-side contact inserted in the receiving part of the plug connector housing with locking mechanism.

20. A plug connector with locking mechanism comprising the plug connector housing with locking mechanism of claim 5 and the plug-connector-side contact inserted in the receiving part of the plug connector housing with locking mechanism.
